(19) United States
(12) Patent Application Publication
(10) Pub. No.: US 2023/0168935 A1
(43) Pub. Date: Jun. 1, 2023

(54) Dynamic Strategy Based Parallelization of User Requests

(71) Applicant: Google LLC, Mountain View, CA (US)

(72) Inventor: Anurag Singla, Cupertino, CA (US)

(73) Assignee: Google LLC, Mountain View, CA (US)

(21) Appl. No.: 17/456,876

(22) Filed: Nov. 29, 2021

(51) Int. Cl. G06F 9/50; G06F 9/52

(52) U.S. Cl. CPC G06F 9/5027; G06F 9/52

(57) ABSTRACT

A method includes receiving a search request to search a portion of a data store and splitting the search request into a plurality of sub-searches. The method also includes selecting a first bucket from a plurality of buckets based on the plurality of sub-searches split from the search request. Each bucket of the plurality of buckets is associated with a respective amount of available resources capable of executing a corresponding maximum number of sub-searches in parallel. The method also includes allocating a first execution set of sub-searches selected from the plurality of sub-searches to the selected first bucket. The method also includes executing, in parallel, each sub-search in the first execution set of sub-searches using the respective amount of available resources associated with the selected first bucket.

### TECHNICAL FIELD

This disclosure relates to dynamic strategy based parallelization of user requests.

### BACKGROUND

Cloud computing systems have increased in popularity as storage of large quantities of data in the cloud becomes more common. Users of the cloud computing systems can store, retrieve, and search large quantities of data by executing operations on distributed computing resources. In some instances, an operation may be delayed because a majority of the computing resources are unavailable due to execution of other operations. In other instances, however, the computing resources remain idle and unutilized in the cloud computing system. Thus, with the increasingly large quantity of data stored on the cloud, managing availability of the computing resources to perform operations on the data is often a cumbersome process.

### SUMMARY

One aspect of the disclosure provides a computer-implemented method that when executed on data processing hardware causes the data processing hardware to perform operations for parallelization of user requests. The operations include receiving a search request to search a portion of a data store and splitting the search request into a plurality of sub-searches. When executed, each sub-search of the plurality of sub-searches is configured to search a different respective sub-portion of the portion of the data store. The operations also include selecting a first bucket from a plurality of buckets based on the plurality of sub-searches split from the search request. Each bucket of the plurality of buckets is associated with a respective amount of available resources capable of executing a corresponding maximum number of sub-searches in parallel. The operations also include allocating, to the selected first bucket, a first execution set of sub-searches selected from the plurality of sub-searches. Here, a number of sub-searches in the first execution set of sub-searches is less than or equal to the corresponding maximum number of sub-searches that the respective amount of available resources associated with the selected first bucket is capable of executing in parallel. The operations also include executing, in parallel, each sub-search in the first execution set of sub-searches in using the respective amount of available resources associated with the selected first bucket.

Implementations of the disclosure may include one or more of the following optional features. In some implementations, when a number of the sub-searches in the plurality of sub-searches split from the search request is less than or equal to the corresponding maximum number of sub-searches that the respective amount of available resources associated with the selected first bucket is capable of executing in parallel. The first execution set of sub-searches includes all of the sub-searches in the plurality of sub-searches split from the search request. In some examples, the operations further include determining whether the first bucket is available. In these examples, when the first bucket is available the operations also include allocating the first execution set of sub-searches to the selected first bucket and executing, in parallel, each sub-search in the first execution set of sub-searches using the respective amount of available resources associated with the selected first bucket.

In some implementations, when the first bucket is not available, the operations further include selecting a second bucket from the plurality of buckets and determining whether the second bucket is available. The corresponding maximum number of sub-searches that the respective amount of available resources associated with the selected second bucket is capable of executing in parallel is less than the corresponding maximum number of sub-searches that the respective amount of available resources associated with the first bucket is capable of executing in parallel. In these implementations, when the second bucket is available, the operations also include allocating a second execution set of sub-searches selected from the plurality of sub-searches to the selected second bucket and executing, in parallel, each sub-search in the second execution set of sub-searches using the respective amount of available resources associated with the selected second bucket. Here, a number of sub-searches in the second execution set of sub-searches is less than or equal to the corresponding maximum number of sub-searches that the respective amount of available resources associated with the selected second bucket is capable of executing in parallel. In some examples, when the second bucket is not available, the operations further include selecting a third bucket from the plurality of buckets and determining whether the third bucket is available. The corresponding maximum number of sub-searches that the respective amount of available resources associated with the selected third bucket is capable of executing in parallel is one. In these examples, when the third bucket is available, the operations also include allocating a single sub-search selected from the plurality of sub-searches to the selected third bucket and executing the single sub-search using the respective amount of available resources associated with the selected third bucket.

After allocating the second execution set of sub-searches to the selected second bucket, the operations may include: identifying one or more sub-searches from the plurality of sub-searches that were not selected for inclusion in the second execution set of sub-searches; waiting until execution of each sub-search in the second execution set of sub-searches using the respective amount of available resources associated with the selected second bucket is complete; allocating the identified one or more sub-searches from the plurality of sub-searches that were not selected for inclusion in the second execution set of sub-searches to the selected second bucket; and executing each sub-search of the identified one or more sub-searches in parallel using the respective amount of available resources associated with the selected second bucket. The search request may include a raw log search of an Internet Protocol (IP) address.

Optionally, the operations may further include: receiving, for each sub-search of the plurality of sub-searches, a respective result; compiling each received result to generate a composite search result; and returning the composite search result to a user associated with the search request. In some examples, after allocating the first execution set of sub-searches to the selected first bucket, the operations further include setting the selected first bucket as not available. In some implementations, after execution of each sub-search in the first execution set of sub-searches using the respective amount of available resources associated with the selected first bucket is complete, the operations further include setting the selected first bucket as available.

Another aspect of the disclosure provides a system that includes data processing hardware and memory hardware storing instructions that when executed on the data processing hardware causes the data processing hardware to perform operations. The operations include receiving a search request to search a portion of a data store and splitting the search request into a plurality of sub-searches. When executed, each sub-search of the plurality of sub-searches is configured to search a different respective sub-portion of the portion of the data store. The operations also include selecting a first bucket from a plurality of buckets based on the plurality of sub-searches split from the search request. Each bucket of the plurality of buckets is associated with a respective amount of available resources capable of executing a corresponding maximum number of sub-searches in parallel. The operations also include allocating, to the selected first bucket, a first execution set of sub-searches selected from the plurality of sub-searches. Here, a number of sub-searches in the first execution set of sub-searches is less than or equal to the corresponding maximum number of sub-searches that the respective amount of available resources associated with the selected first bucket is capable of executing in parallel. The operations also include executing, in parallel, each sub-search in the first execution set of sub-searches in using the respective amount of available resources associated with the selected first bucket.

Implementations of the disclosure may include one or more of the following optional features. In some implementations, when a number of the sub-searches in the plurality of sub-searches split from the search request is less than or equal to the corresponding maximum number of sub-searches that the respective amount of available resources associated with the selected first bucket is capable of executing in parallel. The first execution set of sub-searches includes all of the sub-searches in the plurality of sub-searches split from the search request. In some examples, the operations further include determining whether the first bucket is available. In these examples, when the first bucket is available the operations also include allocating the first execution set of sub-searches to the selected first bucket and executing, in parallel, each sub-search in the first execution set of sub-searches using the respective amount of available resources associated with the selected first bucket.

In some implementations, when the first bucket is not available, the operations further include selecting a second bucket from the plurality of buckets and determining whether the second bucket is available. The corresponding maximum number of sub-searches that the respective amount of available resources associated with the selected second bucket is capable of executing in parallel is less than the corresponding maximum number of sub-searches that the respective amount of available resources associated with the first bucket is capable of executing in parallel. In these implementations, when the second bucket is available, the operations also include allocating a second execution set of sub-searches selected from the plurality of sub-searches to the selected second bucket and executing, in parallel, each sub-search in the second execution set of sub-searches using the respective amount of available resources associated with the selected second bucket. Here, a number of sub-searches in the second execution set of sub-searches is less than or equal to the corresponding maximum number of sub-searches that the respective amount of available resources associated with the selected second bucket is capable of executing in parallel. In some examples, when the second bucket is not available, the operations further include selecting a third bucket from the plurality of buckets and determining whether the third bucket is available. The corresponding maximum number of sub-searches that the respective amount of available resources associated with the selected third bucket is capable of executing in parallel is one. In these examples, when the third bucket is available, the operations also include allocating a single sub-search selected from the plurality of sub-searches to the selected third bucket and executing the single sub-search using the respective amount of available resources associated with the selected third bucket.

After allocating the second execution set of sub-searches to the selected second bucket, the operations may include: identifying one or more sub-searches from the plurality of sub-searches that were not selected for inclusion in the second execution set of sub-searches; waiting until execution of each sub-search in the second execution set of sub-searches using the respective amount of available resources associated with the selected second bucket is complete; allocating the identified one or more sub-searches from the plurality of sub-searches that were not selected for inclusion in the second execution set of sub-searches to the selected second bucket; and executing each sub-search of the identified one or more sub-searches in parallel using the respective amount of available resources associated with the selected second bucket. The search request may include a raw log search of an Internet Protocol (IP) address.

Optionally, the operations may further include: receiving, for each sub-search of the plurality of sub-searches, a respective result; compiling each received result to generate a composite search result; and returning the composite search result to a user associated with the search request. In some examples, after allocating the first execution set of sub-searches to the selected first bucket, the operations further include setting the selected first bucket as not available. In some implementations, after execution of each sub-search in the first execution set of sub-searches using the respective amount of available resources associated with the selected first bucket is complete, the operations further include setting the selected first bucket as available.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system for parallelization of user requests.

FIG. 2 is a schematic view of executing a plurality of sub-searches in parallel using a first selected bucket.

FIGS. 3A and 3B are schematic views of executing a plurality of sub-searches in parallel using a second selected bucket.

FIGS. 4A and 4B are schematic views of executing a plurality of sub-searches sequentially using a third selected bucket

FIGS. 5A and 5B are schematic view of executing a plurality of sub-searches in parallel using a first and second selected bucket.

FIGS. 6A and 6B are flowcharts of an example arrangement of operations for allocating resources from identified underutilized buckets.

FIGS. 7A and 7B are flowcharts of example arrangements of operations for allocating resources for identified over utilized buckets.

FIGS. 8A and 8B are flowcharts of example arrangements of operations for distributing resources when there is a change in the overall amount of resources for the plurality of buckets.

FIG. 9 is a flowchart of an example arrangement of operations for a method of parallelization of user requests.

FIG. 10 is a schematic view of an example computing device that may be used to implement the systems and methods described herein.

Like reference symbols in the various drawings indicate like elements.

### DETAILED DESCRIPTION

Cloud computing systems are growing in popularity as users store and retrieve more data from cloud computing databases. In some instances, users request searches of large amounts data (i.e., hundreds of gigabytes) from cloud databases and expect minimal latency in receiving the requested data. However, search requests over large databases require significant computing resources thereby incurring latency before returning search results to the user. In some examples, cloud computing systems split large search requests into multiple sub-searches and execute the multiple sub-searches in parallel to reduce latency of the search results. Executing multiple sub-searches in parallel, however, can consume a significant amount of the available computing resources. In some instances, large search requests consume all of the computing resources thereby prohibiting other searches from being conducted until computing resources are freed.

Conventional techniques address this issue by either executing the sub-searches one at a time (e.g., sequentially) or by fixing a maximum number of sub-searches that may be executed in parallel. While these techniques address the issue of a single large search request consuming a significant majority of the available computing resources, neither, however, optimize utilization of computing resources by minimizing latency of search results while also maximizing utilization of computing resources. More specifically, limiting the number of sub-searches that can execute in parallel may lead to unnecessary latency (i.e., the searches take longer) while other computing resources are unutilized and could be used to increase the number of sub-searches run in parallel (i.e., reduce the time required to run the search).

Implementations herein are directed towards methods and systems of a dynamic strategy for parallelization of user requests. In particular, a cloud computing environment executes a splitter that splits search requests into a plurality of sub-searches and a selector that allocates computing resources to the plurality of sub-searches based on an availability of computing resources. Thus, the cloud computing environment optimizes utilization of the computing resources by executing the plurality of sub-searches that each searches a separate sub-portion of a database. A plurality of concurrency buckets each represent a differing amount of computing resources that can execute the plurality of sub-searches. The selector allocates the amount of computing resources for a selected bucket to execute the plurality of sub-searches in parallel. Notably, the methods and systems described herein increase computing resource utilization without allowing a single search request to consume all of the computing resources.

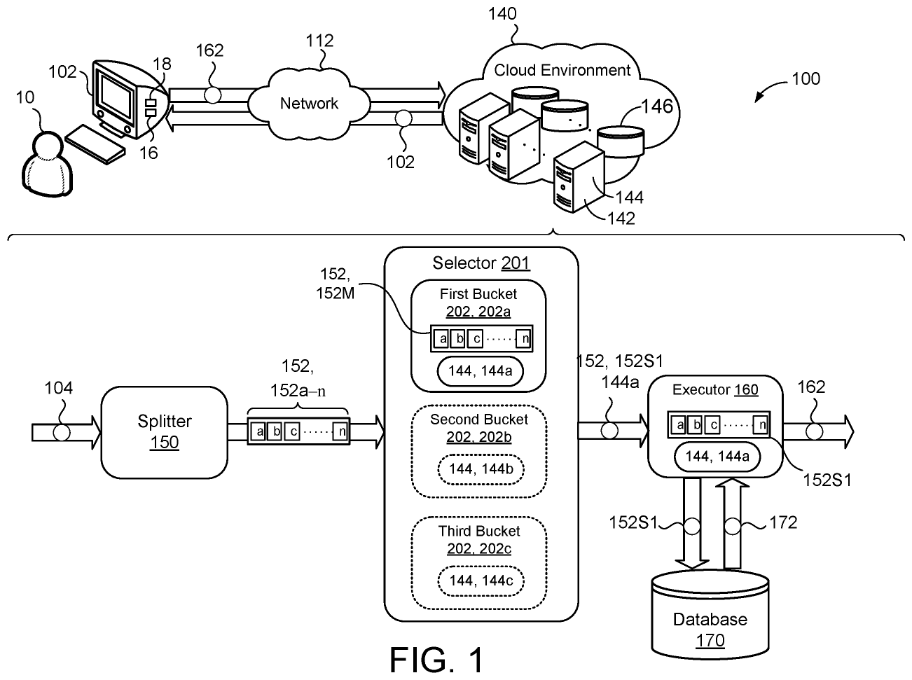

Referring now to FIG. 1, in some implementations, an example system 100 includes one or more user devices 102 each associated with a respective user 10 and in communication with a cloud computing environment 140 via a network 112. Each user device 102 may correspond to a computing device such as a mobile phone, computer, wearable device, smart appliance, audio infotainment system, smart speaker, etc., and is equipped with data processing hardware 16 and memory hardware 18. The cloud computing environment 140 may be a single computer, multiple computers, or a distributed system having scalable/elastic resources 142 including computing resources 144 (e.g., data processing hardware) and/or storage resources 146 (e.g., memory hardware.

The cloud computing environment 140 may execute a splitter 150, a selector 201, an executor 160, and a data store 170. A data store is a repository for persistently storing and managing collections of data which include not just repositories like databases, but also simpler store types, such as simple files, emails, etc. In the examples shown, the data store is a database, but other forms of data storage are possible as well. The data store 170 stores data in the cloud computing environment 140 and may be accessed by the user 10. In other examples, the cloud computing environment 140 includes a file system (not shown) in addition to or in lieu of the data store 170. The file system may store unstructured and/or unrelated data while the data store 170 stores structured and/or related data. Accordingly, the cloud computing environment 140 may store indexed data (i.e., structured data) and/or raw log data (i.e., unstructured data). In some examples, the data store 170 is overlain on the storage resources 146 to allow scalable use of the data store 170 by one or more of the user devices 102 or the computing resources 144. For example, the computing resources 144 can execute storage and retrieval operations on data stored in the data store 170.

In some implementations, the user 10 transmits a search request 104 to the cloud computing environment 140 via the network 112 to search a portion of the data store 170. In some examples, the search request 104 includes a request to search raw logs (i.e., unstructured search) associated with an Internet Protocol (IP) address. Unstructured searches include more comprehensive searches of the data store 170 and take a longer time to execute (e.g., consume more computing resources 144) as compared to structured searches. The user 10 may specify one or more attributes of the search request 104 which determines the portion of the data store 170 to search to satisfy the search request 104. Attributes may include a search timeline, IP address, data format, or any other attribute associated with data stored on the data store 170. For example, the search request 104 may request all raw logs associated with a particular IP address for a particular time frame such as from the past year. In this example, the portion of the data store 170 associated with the search request 104 is all of the raw logs for the particular IP address from the past year.

The splitter 150 receives the search request 104 and is configured to split the search request 104 into a plurality of sub-searches 152, 152a-n. When executed, each sub-search 152 of the plurality of sub-searches 152 is configured to search a different respective sub-portion of the portion of the data store 170. In some examples, the splitter 150 splits the search request 104 into a smallest common sub-portion of the data store 170. Optionally, the user 10 may configure the smallest common sub-portion corresponding to the sub-searches 152. For example, the user 10 may specify whether the splitter 150 splits the search request 104 into sub-searches 152 that include sub-portions each corresponding to a month (i.e., a search of a month's worth of data), week (i.e., a search of a week's worth of data), day (i.e., a search of a day's worth of data), hour (i.e., a search of an hour's worth of data), etc. of the data store 170. The sub-portion of the data store 170 to search may correspond to any attribute of the search request 104. Continuing with the above example, the splitter 150 receives the search request 104 that requests data from the past year and the splitter 150 splits the search request 104 into twelve one-month sub-searches 152. Here, each sub-search 152 includes a separate sub-portion (e.g., one month of data) of the portion (e.g., one year of data) of the data store 170 associated with the search request 104. The splitter 150 sends the plurality of sub-searches 152 to the selector 201.

The selector 201 is configured to select an available concurrency bucket 202 from a plurality of concurrency buckets 202, 202a—n based on a quantity of the plurality of sub-searches 152 (i.e., a concurrency bucket 202 not currently assigned or allocated to any sub-searches 152). Each concurrency bucket (also referred to herein as just “bucket”) 202 of the plurality of buckets 202 is associated with a respective amount of available computing resources 144 capable of executing a corresponding maximum number of sub-searches 152 in parallel. In particular, for a large quantity of sub-searches 152, the selector 201 selects a bucket 202 with greater amount of resources 144 and, for a small quantity of sub-searches 152, the selector 201 selects a bucket with fewer resources 144. In the example shown, each bucket 202a—c is associated with a respective amount of available computing resources 144, 144a—c (i.e., resources such as processing and/or memory resources). Accordingly, the amount of available computing resources 144 associated with a respective bucket 202 refers to the portion of available resources from the total computing resource 144 the respective bucket 202 can execute. For example, a first bucket 202, 202a may be associated with a first amount of resources 144, 144a (e.g., sixty percent of the total computing resource 144) capable of executing six sub-searches 152 in parallel, a second bucket 202, 202b associated with a second amount of resources 144, 144b (e.g., thirty percent of the total computing resource 144) capable of executing three sub-searches 152 in parallel, and a third bucket 202, 202c associated with a third amount of resources 144, 144c (e.g., ten percent of the total computing resource 144) capable of executing one sub-search 152 in parallel. (i.e., 144, 144a. Here, the first amount of resources 144a is greater than the second and third amount of resources 144b, 144c and the second amount of resources 144b is greater than the third amount of resources 144c.

Accordingly, each of the buckets 202 represents a sufficient portion of resources 144 to execute a specific number of sub-searches 152 from the data store 170. For example, when the sub-searches 152 each represent a search of a day's worth of data, one concurrency bucket 202 may represent the amount of computing resources 144 necessary to execute thirty sub-searches 152 (i.e., a month's worth of data) and another bucket 202 may represent the amount of computing resources 144 necessary to execute seven sub-searches 152 (i.e., a week's worth of data).

In some examples, only a portion of resources 144 of a bucket 202 execute in parallel. For example, a bucket 202 may be associated with an amount of resources 144 capable of executing one hundred sub-searches 152. In this example, the bucket 202 is only capable of executing fifty sub-searches 152 in parallel for a single search request 104. Accordingly, a first portion of the bucket 202 may execute up to fifty sub-searches 152 in parallel for a first search request 104 and a second portion of the bucket may execute up to fifty sub-searches in parallel for a second search request 104. In other examples, all of the resources 144 associated with a bucket 202 are capable of executing in parallel.

In some implementations, the selector 201 is configured to select an available bucket 202 from the plurality of buckets 202 that represents the greatest amount of resources 144. Additionally or alternatively, the selector 201 may select the available bucket 202 from the plurality of buckets 202 based on the quantity of the plurality of sub-searches 152. By selecting the bucket 202 that represents the greatest amount of resources 144, the selector 201 helps to minimize execution time of the search requests 104 and maximize utilization of the resources 144. In the example shown, the first bucket 202a, the second bucket 202b, and the third bucket 202c are each available (i.e., not currently assigned or allocated to any sub-searches 152). In this case, the selector 201 selects the first bucket 202a (denoted by the solid lines) while the second and third buckets 202b, 202c are not selected (denoted by the dashed lines), as the first bucket 202a represents the largest number of resources 144.

Optionally, the selector 201 may determine whether the selected bucket (i.e., first bucket) 202a is available. In some implementations, the selector 201 determines which buckets 202 are available prior to selecting a bucket 202. The selector 201 may determine whether a bucket 202 is available based on the availability of the computing resources 144 represented by the bucket 202. That is, if there is not a sufficient number of resources 144 available to satisfy the amount of sub-searches a bucket 202 is configured to execute, the bucket 202 may be deemed unavailable. In this instance, the selector 201 determines whether the bucket 202 with the next greatest amount of resources 144 is available. In other implementations, the selector 201 determines which buckets 202 are available after selecting a bucket 202.

In some examples, the selector 201 determines whether the quantity of the plurality of sub-searches 152 to be executed in parallel satisfies a threshold value prior to selecting the bucket 202. The threshold value may be proportional to the number of sub-searches 152 a bucket 202 can execute in parallel. In these examples, the threshold value ensures that the selector 201 selects the bucket 202 with the least amount of resources 144 capable of executing the quantity of the plurality of sub-searches 152. For example, when one bucket 202 represents resources 144 to execute thirty sub-searches 152 in parallel and a second bucket 202 represents resources 144 to execute seven sub-searches 152 in parallel, the threshold value for the first bucket 202 may be eight. As such, the threshold value of eight ensures that the selector does not select the first bucket 202 when the plurality of sub-searches 152 only includes eight or less sub-searches 152 when the second bucket 202 is available and capable of executing the eight or less sub-searches 152. That is, the selector 201 may only select the first bucket 202 when the number of sub-searches 152 is greater than or equal to eight. In this example, allocating a plurality of sub-searches 152 including three sub-searches to the first bucket 202 would be wasteful if the second bucket 202 is also available and capable of executing all of the sub-searches 152. Thus, one or more of the plurality of buckets 202 may be unavailable for selection when the quantity of the plurality of sub-searches 152 does not satisfy the threshold value.

In some instances, the selector 201 may determine that the first bucket 202a is available but the quantity of the plurality of sub-searches 152 does not satisfy a threshold value of a first bucket 202a. Thus, the selector 201 determines whether a second bucket 202b is available. Here, the selector 201 may determine that the second bucket 202b is not available. In this instance, the selector 201 may select the first bucket 202a even though the quantity of the plurality of sub-searches 152 does not satisfy the threshold value of the first bucket 202a because the second bucket 202b (e.g., bucket 202 with the next greatest amount of resources 144) is not available. When the plurality of sub-searches 152 does not satisfy the threshold value of a particular bucket 202, the selector 201 may first determine whether any of the buckets 202 with a greater amount of resources 144 than the particular bucket 202 are available before determining whether any of the buckets 202 with a fewer amount of resources 144 than the particular bucket 202 are available.

With continued reference to the example of FIG. 1, when the first bucket 202a is available, the selector 201 allocates a first execution set of sub-searches 152, 152S1 selected from the plurality of sub-searches 152 to the first amount of resources 144a associated with the first bucket (i.e., selected first bucket) 202a. Here, a number of sub-searches 152 in the first execution set 152S1 is less than or equal to the corresponding maximum number of sub-searches 152 that the first amount of resources 144a associated with he selected first bucket is capable of executing in parallel. Notably, the first execution set of sub-searches 152 may include all of the sub-searches 152 in the plurality of sub-searches 152 or, alternatively, include only a portion of the sub-searches 152 in the plurality of sub-searches 152. When the first execution set 152S1 includes only a portion of the sub-searches 152, the selector 201 still allocates the entire first amount of computing resources 144a for the first execution set 152S1. That is, in some examples, there may not be more than one execution set allocated to a single bucket 202. For example, when a bucket 202 includes an amount of resources 144 capable of executing thirty sub-searches 152 and the plurality of sub-searches 152 includes twenty-one sub-searches 152, the first execution set 152S1 includes twenty-one sub-searches 152 (i.e., the lesser of thirty and twenty-one). Alternatively, where the bucket 202 includes an amount resources 144 capable of executing fourteen sub-searches 152 and the plurality of sub-searches 152 includes twenty-one sub-searches 152, the first execution set 152S1 of sub-searches 152 includes fourteen sub-searches 152 (i.e., the lessor of twenty-one and fourteen). In some implementations, after allocating the first execution set 15251 of sub-searches 152 to the selected first bucket 202a, the selector 201 sets an indicator that indicates the first bucket 202a is not available.

In this example, the selector 201 transmits the first execution set 152S1 of sub-searches 152 and the first amount of resources 144a represented by the first bucket 202a to the executor 160. The executor 160 executes each sub-search 152 of the first execution set 152S1 in parallel using the first amount of resources 144a. That is, the executor 160 executes each sub-search 152 to retrieve results from the corresponding sub-portion from the data store 170. For each sub-search 152 of the plurality of sub-searches 152, the executor 160 receives a respective result 172 from the data store 170. The respective result 172 corresponds to the sub-portion of the respective sub-search 152. The executor 160 compiles each of the received results 172 to generate a composite search result 162. Continuing with the example above, the executor 160 receives results 172 for each one month sub-search 152 of the twelve sub-searches 152 and compiles the results 172 to generate the composite search result 162 for the past year search request 104.

In some implementations, after executing each sub-search 152 in the first execution set 152S1 of sub-searches 152 using the first amount of resources 144a is complete, the selector 201 sets an indicator that indicates the first bucket 202a is available. Optionally, the executor 160 may communicate the composite search result 162 to the user 10 via the network 112. The user device 102 may display the received composite search result 162 to the user 10 via a graphical user interface (GUI).

By allocating sub-searches 152 to resources 144 dynamically based on the quantity of sub-searches 152 and the availability of the resources 144, usage of the resources 144 becomes more predictable and may in some instances flatten the usage of the resources over a longer duration. Moreover, a maximum number of resources 144 may be allocated to search requests 104 when the resources 144 are available without leading to starvation of resources 144 for other search requests 104. In some implementations, when all computing resources 144 are allocated (i.e., none of the buckets 202 are available), the cloud computing environment 140 prioritizes shorter duration search requests 104. Prioritizing the shorter duration search requests 104 allows the shorter duration searches to execute normally while longer duration search requests 104 may incur increased latency.

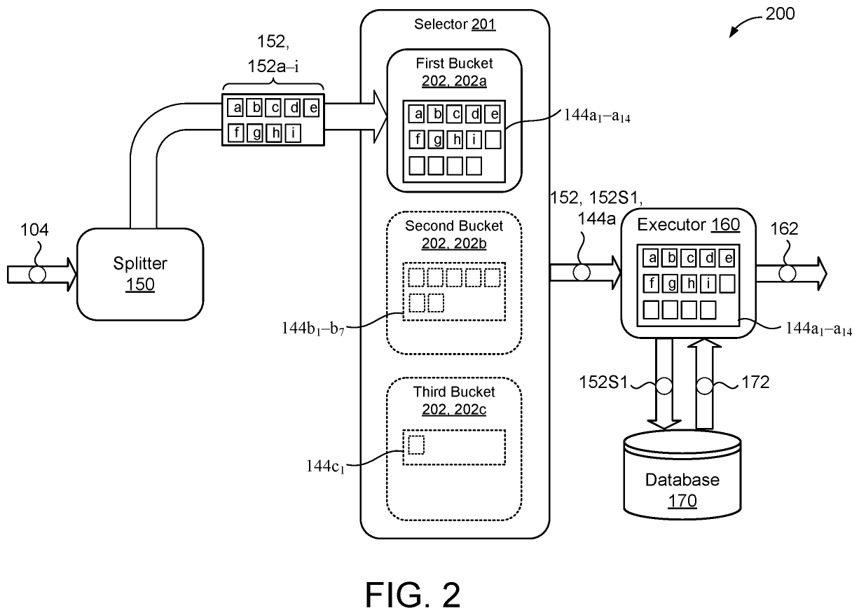

Referring now to FIGS. 2-4, in some implementations, the splitter 150 receives a search request 104 to search a portion of the data store 170. In the example shown, the smallest common sub-portion is equivalent to a day of data. Here, the splitter 150 receives a search request 104 that requests searching nine days of data, and the splitter 150 splits the search request 104 into nine sub-searches 152, 152a-i. Here, each of the nine sub-searches 152 represents a one day of data sub-portion of the portion of the data store 170. The selector 201 may receive the plurality of sub-searches 152 from the splitter 150 and is configured to select the available bucket 202 with the greatest amount of resources 144 (e.g., based on the threshold value). In some examples, the selector 201 selects the available bucket 202 based on a quantity of the plurality of sub-searches split from the search request 104. In this example, the first amount of resources 144a of the first bucket 202a includes fourteen resources 144a1-a₁₄, the second amount of resources 144b of the second bucket 202b includes seven resources 144b₁-b₇, and the third amount of resources 144c of the third bucket 202c includes one resource 144c₁.

An exemplary schematic view 200 (FIG. 2) illustrates the selector 201 determining the first bucket 202a is available and selecting the first bucket 201a (denoted by the solid line). As such, the selector 201 allocates a first execution set 152S1 of sub-searches 152 selected from the plurality of sub-searches 152 to the first amount of computing resources 144a associated with the first bucket 202a. When a number of the sub-searches 152 in the plurality of sub-searches 152s split from the search request is less than or equal to the corresponding maximum number of sub-searches 152 that the respective amount of available resources 144 associated with the selected bucket is capable of executing in parallel, the first execution set 152S1 includes all of the sub-searches 152 in the plurality of sub-searches 152 split from the search request 104. In the example shown, the plurality of sub-searches 152 includes nine sub-searches 152 which is less than the maximum number of sub-searches 152 the selected first bucket 202a is capable of executing in parallel (e.g., the first bucket 202a is capable of executing fourteen sub-searches 152 in parallel). Thus, the first execution set 152S1 of sub-searches 152 includes all nine of the sub-searches 152 in the plurality of sub-searches 152 from the search request 104. Notably, the remaining resources from the first amount of resources 144a do not include a sub-search 152 from the first execution set 152S1. The selector 201 sends the first execution set 152S1 and the second amount of resources 144b to the executor 160. The executor 160 executes each of sub-search 152 of the first execution set 152S1 in parallel using the first amount of resources 144a. The executor 160 receives a respective result 172 for each sub-search 152 of the first execution set 152S1 and compiles the results 172 to generate a composite search result 162. The composite search result 162 represents data corresponding to the portion of the data store 170 associated with the search request 104.

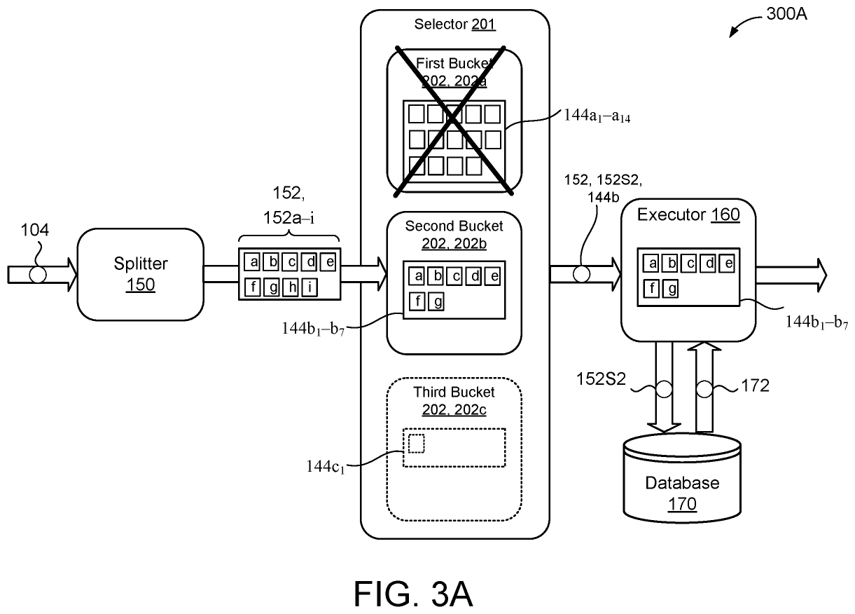

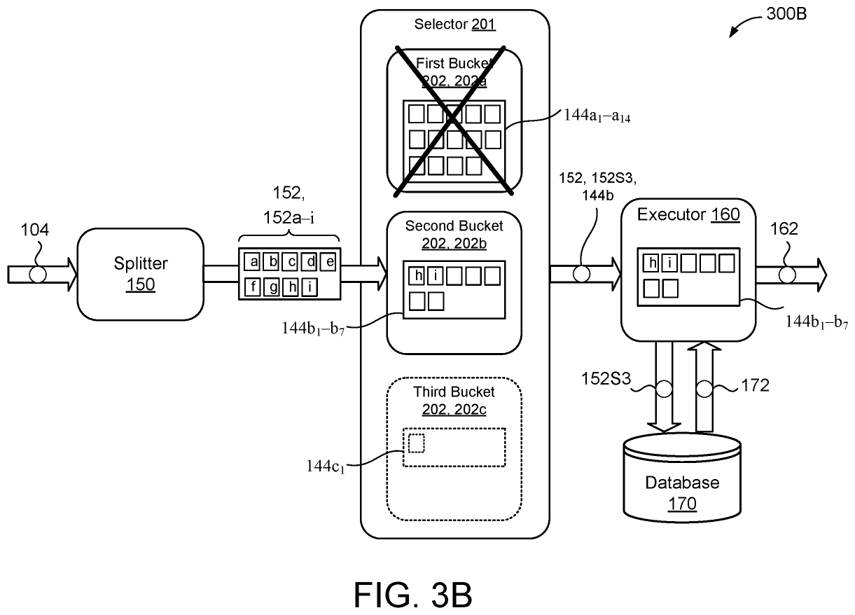

FIGS. 3A and 3B illustrate schematic views 300A (FIG. 3A) and 300B (FIG. 3B) of the selector 201 determining that the first bucket 201a is not available (as shown by the X through the first bucket 202a). Referring now to FIG. 3A, when the first bucket 202a is not available, the selector 201 determines whether the second bucket 202b is available and selects the second bucket (i.e., second selected bucket) 202b from the plurality of buckets 202. Here, the corresponding maximum number of sub-searches 152 that second amount of resources 144b is capable of executing in parallel is less than the corresponding maximum number of sub-searches 152 that the first amount of resources 144a is capable of executing in parallel. When the second bucket 202b is available, the selector 201 allocates a second execution set of sub-searches 152, 152S2 selected from the plurality of sub-searches 152 to the second amount of resources 144b associated with the second bucket 202b. The number of sub-searches 152 in the second execution set 152S2 of sub-searches 152 is less than or equal to the corresponding maximum number of sub-searches 152 that the second amount of resources 144b is capable of executing in parallel. In this example, the number of sub-searches 152 in the plurality of sub-searches 152 (e.g., nine sub-searches 152) split from the search request 104 is greater than the corresponding maximum number of sub-searches 152 that the second amount of resources 144b is capable of executing in parallel (e.g., the second bucket 202b capable of executing seven sub-searches 152). Accordingly, the second execution set 152S2 of sub-searches 152 includes only a portion of the sub-searches 152 in the plurality of sub-searches 152 split from the search request 104. The selector 201 sends the second execution set 152S2 and the second amount of computing resources 144b associated with the second bucket 202b to the executor 160. The executor 160 executes each sub-search 152 of the second execution set 152S2 in parallel using the second amount of resources 144b. The executor 160 receives a respective result 172 from the data store 170 for each sub-search 152 of the second execution set 152S2. Notably, the executor 160 does not yet generate a composite search result 162 because the executor 160 has not executed the eighth and ninth sub-search 152h, 152i. The executor 160 may not generate the composite search result 162 until each sub-search 152 corresponding to the entire portion of the data store 170 associated with the search request 104 is executed.

Referring now to FIG. 3B, continuing the example of FIG. 3A, after allocating the second execution set 152S2 to the selected second bucket 202b, the executor 160 and/or selector 201 identifies one or more sub-searches 152 of the plurality of sub-searches 152 that were not selected for inclusion in the second execution set 152S2 of sub-searches 152. In some examples, the one or more sub-searches 152 that were not selected for inclusion in the second execution set 152S2 of sub-searches 152 are not eligible until execution of the previous execution set is complete. Here, the selector 201 identifies the eighth and ninth sub-search 152h, 152i from the plurality of sub-searches 152 that were not previously executed by the second bucket 202b. The selector 201 allocates the one or more identified sub-searches 152 from the plurality of sub-searches 152 (i.e., a third execution set 152, 152S3) to the second amount of computing resources 144b of the second bucket 202b. Optionally, the selector 201 may determine whether the second bucket 202b is still available before allocating the third execution set 152S3. The third execution set 152S3 of sub-searches 152 may be different or the same as the second execution set 152S2. Here, the third execution set 152S3 includes to two sub-searches 152 (i.e., the two remaining sub-searches after the second bucket 202b selected seven of the nine total sub-searches). The selector 201 may wait until execution of each sub-search 152 of the second execution set 152S2 is complete before allocating the third execution set 152S3 of sub-searches 152 to the second bucket 202b. The executor 160 receives the third execution set 152S3 of sub-searches 152 and executes each sub-search 152 of the third execution set 152S3 of sub-searches in parallel using the second amount of resources 144b. The executor 160 receives respective results 172 for each sub-search 152 of the third execution set 152S3. Moreover, the executor 160 compiles the results from the second and third execution set 152S2, 152S3 of sub-searches 152 and generates the composite search result 162. Here, the composite search result 162 represents data corresponding to the portion of the data store 170 associated with the search request 104.

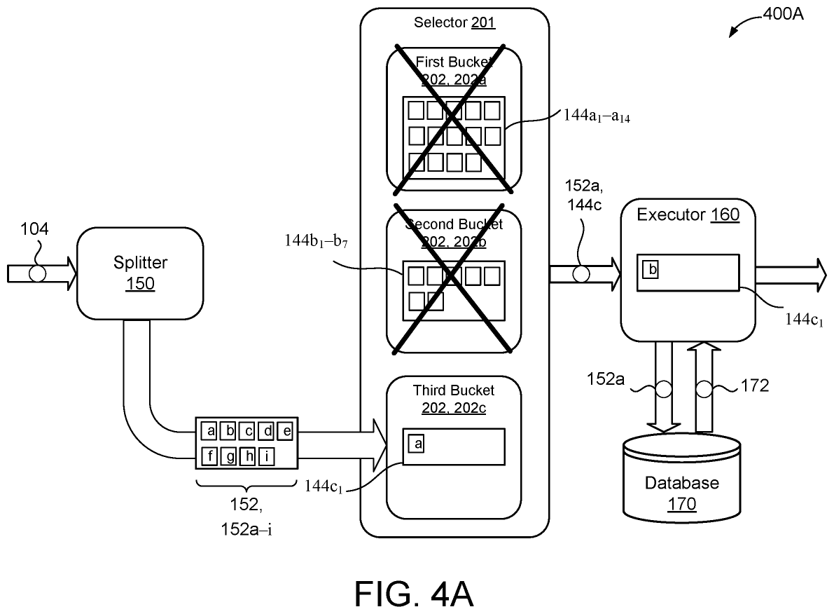

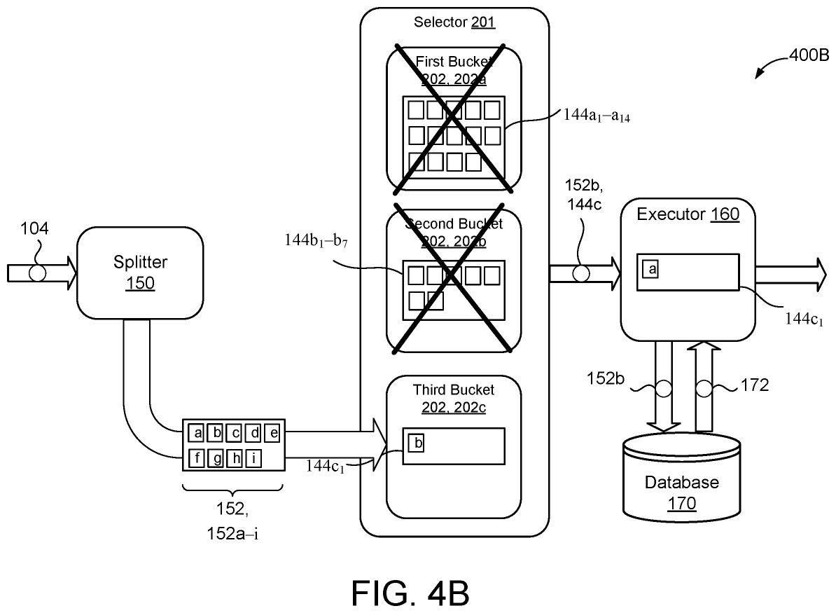

FIGS. 4A and 4B illustrate schematic views 400A (FIG. 4A) and 400b (FIG. 4B) of the selector 201 determining that neither the first bucket 201a nor the second bucket 201b is available. Referring now to the example of FIG. 4A, when neither the first bucket 202a nor the second bucket 202b is available, the selector 201 determines whether the third bucket 202c is available and selects the third bucket (i.e., third selected bucket) 202c from the plurality of buckets 202. In this example, the third bucket 202c executes sub-searches 152 sequentially (i.e., only a single sub-search 152 at a time). That is, the corresponding maximum number of sub-searches that the third amount of computing resources 144c associated with the third bucket 202c is capable of executing in parallel is one. In some examples, the third bucket 202c (e.g., sequential bucket) allows for overbooking. Here, overbooking refers to allocating more sub-searches 152 to a bucket 202 than the bucket 202 is capable of executing in parallel. Accordingly, overbooking may create a queue of sub-searches 152 that execute sequentially as resources 144 become available.

When the third bucket 202c is available, the selector 201 allocates a first single sub-search 152a (i.e., a fourth execution set) selected from the plurality of sub-searches 152 to the third amount of resources 144c associated with the third bucket 203c. The selector 201 sends the first single sub-search 152a of the plurality of sub-searches 152 and the third amount of computing resources 144c associated with the third bucket 202c to the executor 160. The executor 160 executes the first single sub-search 152a and receives a result 172 for the first single sub-search 152a. Notably, the executor 160 does not yet generate a composite search result 162 because the executor 160 has not executed the second through ninth sub-searches 152b-i. Thus, the executor 160 cannot generate the composite search result 162 corresponding to the entire portion of the data store 170 associated with the search request 104.

Referring now to FIG. 4B, in some implementations, the executor 160 and/or selector 201 identifies at least one sub-search 152 of the plurality of sub-searches 152 that was not allocated to the third amount of resources 144c of the third bucket 202c. In the example shown, the selector 201 identifies the second through ninth sub-search 152b-i from the plurality of sub-searches 152 that were not executed. Therefore, the selector 201 allocates a second single sub-search 152, 152b to the third amount of computing resources 144c of the third bucket 202c. The selector 201 may wait until execution of first single sub-search 152a is complete before allocating the second single sub-search 152b. The executor 160 receives the second single sub-search 152b and the third amount of computing resources 144c. Thereafter, the executor 160 executes the second single sub-search 152b using the third amount of computing resources 144c and receives the result 172 corresponding with the second single sub-search 152b. For sake of clarity, FIGS. 4A and 4B only illustrate the first two single sub-searches 152 executing sequentially using the third amount of computing resources 144c of the third bucket 202c. It is understood execution and allocation of the sub-searches 152 would continue until all sub-searches 152 from the plurality of sub-searches 152 are executed and the executor 160 generates a composite search result 162 for the search request 104.

It is also understand that examples herein include only two or three buckets 202. However, the system 100 may include any number of buckets 202, including multiple buckets of the same size (i.e., capable of executing the same number of sub-searches 152 in parallel). For example, a system may include five buckets 202 capable of executing thirty sub-searches 152 in parallel, ten buckets 202 capable of executing seven sub-searches 152 in parallel, and one hundred buckets 202 capable of sequentially executing sub-searches 152. There may be any number of sizes of buckets (e.g., years, months, weeks, days, hours, minutes, etc.).

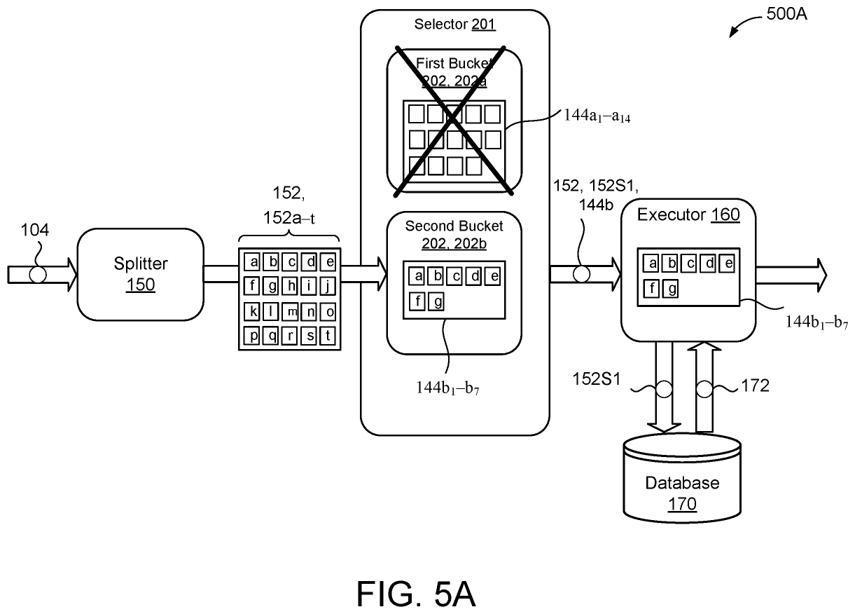

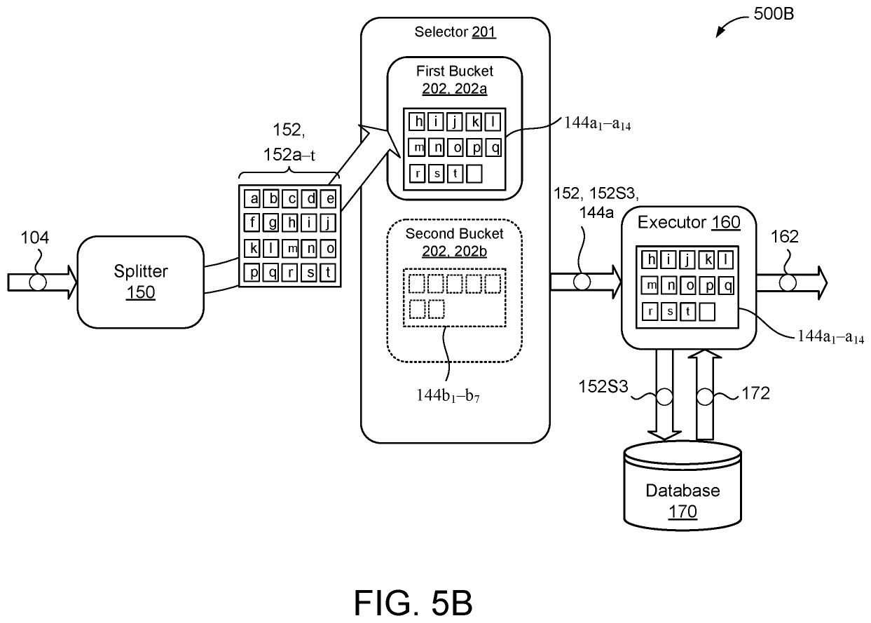

FIGS. 5A and 5B illustrate schematic views 500A (FIG. 5A) and 500B (FIG. 5B) that illustrate, after execution of a execution set of sub-searches 152 using resources 144 of a selected bucket 202, the selector 201 determining another bucket 202 that includes a greater amount of computing resources 144 is now available. In the example shown, the splitter 150 receives a search request 104 to search a portion of the data store 170 corresponding to twenty days and splits the search request 104 into twenty sub-searches 152, 152a-t. As shown in FIG. 5A, the selector 201 determines that the first bucket 201a is not available (as shown by the X through the first bucket 202a). Accordingly, the selector 201 determines whether the second bucket 201b is available, and when the second bucket 201b is available the selector 201 selects the second bucket 201b. The selector 201 allocates a second execution set 152S2 of sub-searches 152 to the selected second bucket 202b. The selector 201 sends the second execution set 152S2 of sub-searches 152 and the second amount of computing resources 144b associated with the second bucket 202b to the executor 160. The executor 160 executes each of sub-search 152 of the second execution set 152S2 of sub-searches 152 in parallel using the second amount of resources 144b. The executor 160 receives a respective result 172 for each sub-search 152 of the second execution set 152S2.

Referring now to FIG. 5B, in some implementations, the executor 160 and/or selector 201 identifies at least one sub-search 152 of the plurality of sub-searches 152 that were not selected for inclusion in the second execution set 152S2. In the example shown, the selector 201 identifies sub-searches 152h—t from the plurality of sub-searches 152 that were not included in the second execution set 152S2. Now, the selector 201 determines that first bucket 202a is now available (e.g., the first bucket 202a was not available for the second execution set 152S2). For example, the first amount of computing resources 144a may have completed execution during execution of the second execution set 152S2. As such, because the first bucket 201a is now available, the selector 201 allocates a third execution set 152S3 of sub-searches 152 to the first amount of computing resources 144a of the first bucket 202a. The executor 160 receives the third execution set 152S3 of sub-searches 152 and executes each sub-search 152 of the third execution set 152S3 of sub-searches 152 in parallel using the first amount of resources 144b associated with the first bucket 202a. The executor 160 receives respective results 172 for each sub-search 152 of the third execution set 152S3. Notably, the plurality of sub-searches completed execution in two execution cycles (e.g., initially using resources 144 of the second bucket 202b and subsequently using resources of the first bucket 202a) as compared to the three execution cycles that the second bucket 202b would have required.

In some implementations, one bucket 202 of the plurality of buckets 202 is underutilized. In particular, an underutilized bucket 202 refers to a bucket 202 that has idle computing resources 144 (e.g., the idle computing resources 144 are not executing sub-searches 152). Optionally, computing resources 144 may only be identified as idle when the computing resources 144 do not execute at least one sub-search 152 for a threshold amount of time. In these implementations, one or more other buckets 202 of the plurality of buckets 202 may be over utilized. As such, it is a more efficient utilization of all of the computing resources 144 in this scenario to merge all of, or some of, the computing resources 144 from the underutilized bucket 202 to the one or more other buckets 202.

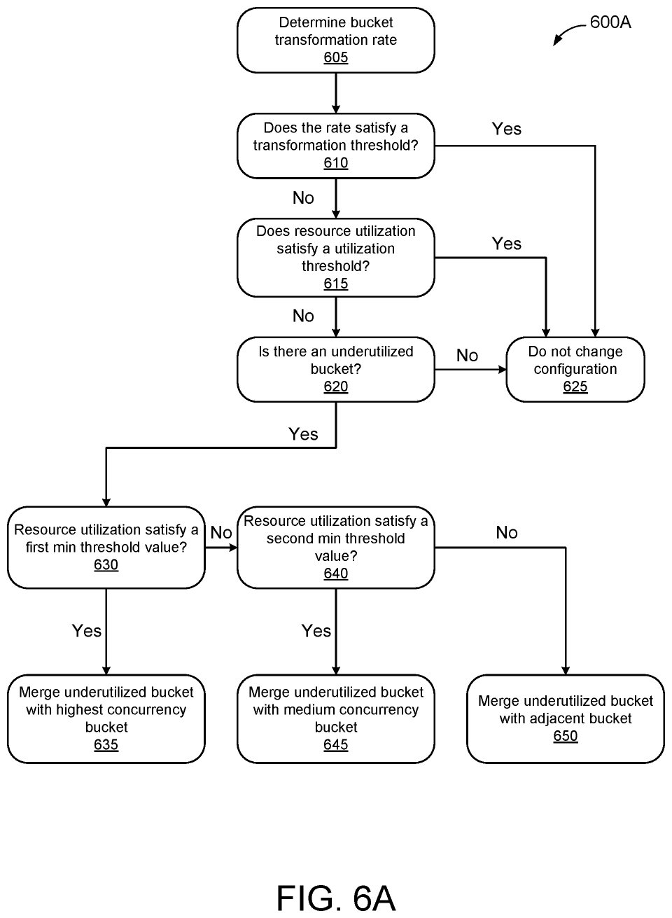

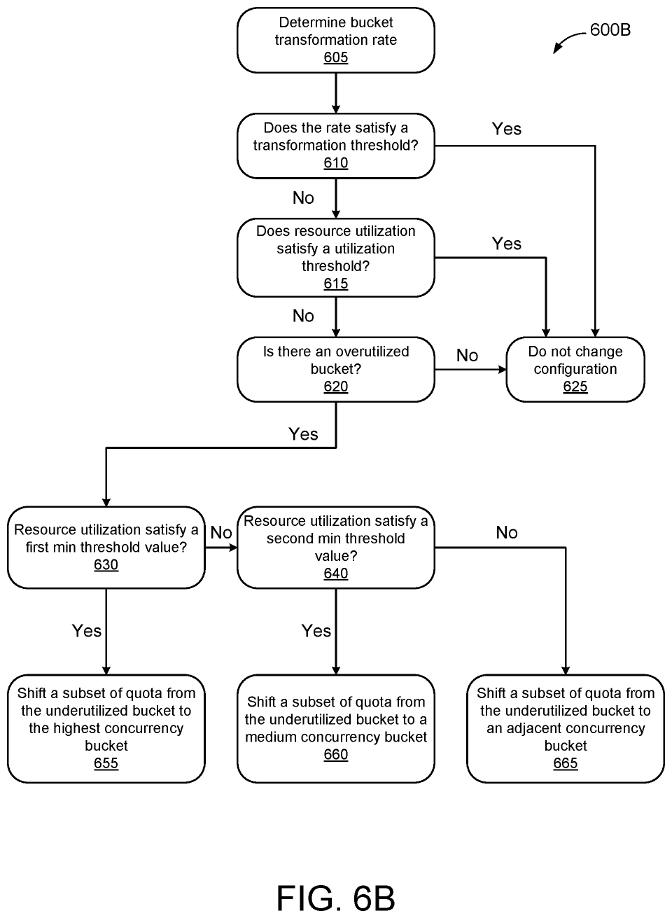

FIGS. 6A and 6B illustrate schematic views 600A (FIG. 6A) and 600B (FIG. 6B) that illustrate exemplary operations the cloud computing environment 140 performs on an identified underutilized bucket 202. In the example shown, at operation 605, the cloud computing environment 140 determines a bucket transformation rate for the plurality of buckets 202. In particular, the bucket transformation rate indicates a rate at which one or more buckets 202 of the plurality of buckets 202 merge resources 144 into a single bucket 202 and/or a rate at which at least one bucket 202 of the plurality of buckets split resources 144 into two or more buckets 202. At operation 610, the cloud computing environment 140 determines whether the bucket transformation rate satisfies a transformation threshold value. When the transformation rate satisfies the transformation threshold value (e.g., the transformation rate exceeds the transformation threshold value), the cloud computing environment 140 proceeds to operation 625 and does not change the configuration of the plurality of buckets 202. That is, the cloud computing environment 140 does not merge or shift computing resources from any bucket 202 of the plurality of buckets 202. Alternatively, when the transformation rate fails to satisfy the transformation threshold value (e.g., the transformation rate does not exceed the transformation threshold value), the cloud computing environment proceeds to operation 615 to determine a resource utilization of all of the plurality of buckets 202 in the system, and using the resource utilization rate the cloud computing environment 140 determines whether the resource utilization satisfies a utilization threshold value.

Continuing with the example, when the resource utilization rate satisfies the utilization threshold value (e.g., the utilization rate exceeds the utilization rate threshold value), the cloud computing environment 140 proceeds to operation 625 and does not change the configuration of the plurality of buckets 202. Alternatively, When the resource utilization fails to satisfy the utilization threshold value (e.g., the utilization rate does not exceed the utilization rate threshold value), the cloud computing environment 140 proceeds to operation 620 to determine whether there is an underutilized bucket 202 from the plurality of buckets 202.

In some instances, when there is not an underutilized bucket 202 from the plurality of buckets 202, the cloud computing environment 140 proceeds to operation 625 and does not change the configuration of the plurality of buckets 202. At operation 630, when there is an underutilized bucket 202 in the plurality of buckets 202, the cloud computing environment 140 determines whether the resource utilization satisfies a first minimum threshold value. If the resource utilization fails to satisfy the first min threshold value (e.g., the resource utilization exceeds the first minimum threshold value), the cloud computing environment 140 proceeds to operation 640. At operation 640, the cloud computing environment 140 determines whether the resource utilization satisfies a second minimum threshold value (e.g., the resource utilization is between the first minimum threshold value and the second minimum threshold value).

Referring now to specifically to FIG. 6A, when the resource utilization satisfies the first minimum threshold value (e.g., the resource utilization does not exceed the first minimum threshold value), the cloud computing environment 140 proceeds to operation 635 and merges the identified underutilized bucket 202 with the bucket 202 of the plurality of buckets 202 with the greatest amount of computing resources 144 (i.e., highest concurrency bucket 202). For example, the first minimum threshold value may represent forty percent resource utilization for all of the computing resources 144. Here, merging the identified underutilized bucket 202 refers to merging the computing resources 144 of the underutilized bucket 202 with computing resources 144 of another bucket 202 of the plurality of buckets 202. The cloud computing environment 140 may merge the computing resources 144 from the other bucket 202 and the identified underutilized bucket 202 into either the identified underutilized bucket 202 or the other bucket 202. In other instances, the cloud computing environment 140 may merge the computing resources 144 from the other bucket 202 and the identified underutilized bucket 202 into a new bucket 202. Accordingly, the bucket 202 that receives the merged computing resources 144 from the other bucket 202 and the identified underutilized bucket 202 includes an amount of computing resources 144 equal to the amount of computing resources 144 of the other bucket 202 and the identified underutilized bucket 202 combined.

In other examples, the cloud computing environment 140 proceeds to operation 645 when the resource utilization satisfies a second minimum threshold value (e.g., the resource utilization is greater than the first minimum threshold value and does not exceed the second threshold value). For example, the second minimum threshold value may represent between forty percent resource utilization and sixty percent resources utilization for all of the computing resources 144. At operation 645, the cloud computing environment 140 merges the identified underutilized bucket 202 with a bucket 202 from the plurality of buckets 202 that has a medium amount of computing resources 144 (e.g., medium concurrency bucket 202). Here, buckets 202 with medium amounts of computing resources 144 may have an amount computing resources 144 between a minimum resource value and a maximum resource value.

In some examples, when the resource utilization fails to satisfy the second minimum threshold value (e.g., the resource utilization exceeds the second minimum threshold value), the cloud computing environment 140 proceeds to operation 650 and merges the identified underutilized bucket 202 with a bucket 202 with the next greatest amount of computing resources 144 than the identified underutilized bucket 202. 144. For example, if the identified underutilized bucket 202 is the second bucket 202b (FIG. 1), the cloud computing environment 140 merges the computing resources 144b of the second bucket 202b with computing resources 144a of the first bucket 202a. In this example, the first bucket 202a has the next greatest amount of computing resources 144 than the second bucket 202b.

Referring now specifically to FIG. 6B, in some implementations, when the resource utilization satisfies the first minimum threshold value, the cloud computing environment 140 proceeds to operation 655 and shifts a sub-set of quota from the identified underutilized bucket 202 to the bucket 202 with the greatest amount of computing resources 144. Here, shifting the sub-set of quota from the underutilized bucket 202 refers to taking only a portion of the amount of computing resources 144 from the identified underutilized bucket 202 to combine with computing resources 144 of another bucket 202 of the plurality of buckets 202. Thus, after shifting the sub-set of computing resources 144, the identified underutilized bucket 202 still includes a lesser amount of computing resources 144 and the other bucket 202 includes a greater amount of computing resources 144. In some examples, the cloud computing environment 140 shifts computing resources 144 from the underutilized bucket 202 to one or more other buckets 202.

In other examples, the cloud computing environment 140 proceeds to operation 660 when the resource utilization satisfies the second minimum threshold value. At operation 660, the cloud computing environment 140 shifts the subset of quote from the identified underutilized bucket 202 to a bucket 202 from the plurality of buckets 202 that has a medium amount of computing resources 144 (e.g., medium concurrency bucket 202). Here, buckets 202 with medium amounts of computing resources 144 may have an amount computing resources 144 between a minimum resource value and a maximum resource value. In some examples, when the resource utilization fails to satisfy the second minimum threshold value, the cloud computing environment 140 proceeds to operation 665 and shifts the subset of quota from the identified underutilized bucket 202 to a bucket 202 with the next greatest amount of computing resources 144 than the identified underutilized bucket 202.

In some implementations, one bucket 202 of the plurality of buckets 202 is over utilized. In particular, an over utilized bucket 202 refers to a bucket 202 that satisfies a threshold percentage of its computing resources executing sub-searches 152. In these implementations, it may be efficient to split the computing resources 144 of the over utilized bucket 202 into two or more bucket 202.

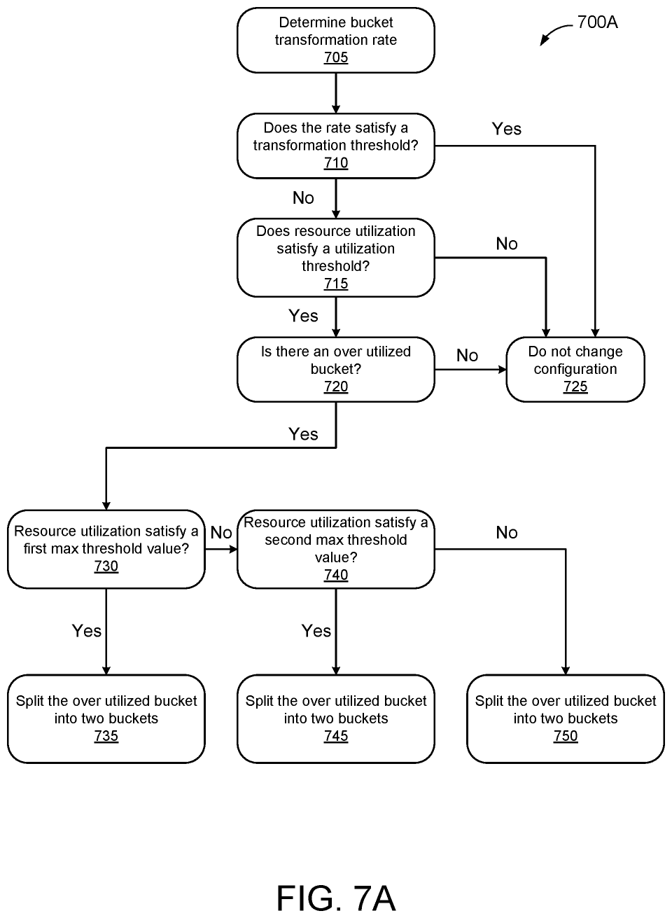

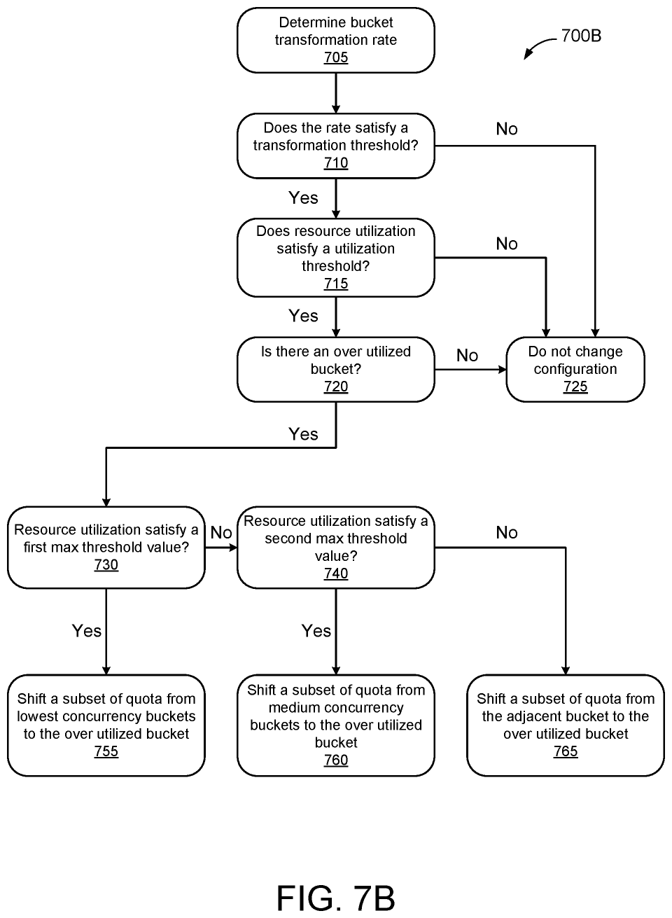

FIGS. 7A and 7B illustrate schematic views 700A (FIG. 7A) and 700B (FIG. 7B) that illustrate exemplary operations the cloud computing environment 140 performs on an identified over utilized bucket 202. In the example shown, at operation 705, the cloud computing environment 140 determines a bucket transformation rate for the plurality of buckets 202. At operation 710, the cloud computing environment 140 determines whether the bucket transformation rate satisfies a transformation threshold value. In some examples, when the transformation rate satisfies the transformation threshold value (e.g., the transformation rate exceeds the transformation threshold value), the cloud computing environment 140 proceeds to operation 725 and does not change the configuration of the plurality of buckets 202 (FIG. 7A). In other examples, when the transformation rate fails to satisfy the transformation threshold value (e.g., the transformation rate does not exceed the transformation threshold value), the cloud computing environment 140 proceeds to operation 725 and does not change the configuration of the plurality of buckets 202 (FIG. 7B). That is, the cloud computing environment 140 does not shift or split computing resources from any bucket 202 of the plurality of buckets 202.

In some implementations, when the transformation rate fails to satisfy the transformation threshold value (e.g., the transformation rate does not exceed the transformation threshold value), the cloud computing environment 140 proceeds to operation 715 (FIG. 7A). In other implementations, when the transformation rate satisfies the transformation threshold value, the cloud computing environment 140 proceeds to operation 715 (FIG. 7B). At operation 715, the cloud computing environment 140 identifies whether there is an over utilized bucket 202 in the plurality of buckets 202. In some instances, when there is not an over utilized bucket 202 from the plurality of buckets 202, the cloud computing environment 140 proceeds to operation 725 and does not change the configuration of the plurality of buckets 202. In other instances, at operation 730, when there is an over utilized bucket 202 in the plurality of buckets 202, the cloud computing environment 140 determines whether the resource utilization satisfies a first maximum threshold value. If the resource utilization fails to satisfy the first maximum threshold value (e.g., the resource utilization exceeds the first maximum threshold value), the cloud computing environment 140 proceeds to operation 740. At operation 740, the cloud computing environment 140 determines whether the resource utilization satisfies a second maximum threshold value (e.g., the resource utilization is between the first maximum threshold value and the second maximum threshold value).

Referring now to specifically to FIG. 7A, when the resource utilization satisfies the first maximum threshold value (e.g., the resource utilization exceeds the first maximum threshold value), the cloud computing environment 140 proceeds to operation 735 and splits the computing resources 144 of the identified over utilized bucket 202 into two or more buckets 202. For example, the first maximum threshold value may represent ninety-five percent resource utilization for all of the computing resources 144. Here, the cloud computing environment 140 determines an amount of computing resources 144 for each of the two or more buckets 202 that the cloud computing environment 140 splits the identified over utilized bucket 202 into based on the amount of resource utilization. Next, the cloud computing environment 140 splits the identified over utilized bucket 202 into the two buckets. Notably, a first bucket 202 of the two or more buckets 202 includes the same amount of computing resources 144 as the identified over utilized bucket. Moreover, a second bucket 202 of the two or more buckets 202 includes an amount of computing resources 144 between the two buckets 202 with the least amount of computing resources 144 above a first specified threshold. Put another way, the cloud computing environment 140 adds the second bucket 202 of the two or more buckets 202 to the plurality of buckets 202.

In some examples, when the resource utilization fails to satisfy the first maximum threshold value (e.g., the resource utilization does not exceed the first maximum threshold value), the cloud computing environment 140 proceeds to operation 740 and determines whether the resource utilization satisfies a second maximum threshold value (e.g., the resource utilization is between the first maximum threshold value and the second maximum threshold value). For example, the second maximum threshold value may represent eighty-five percent resource utilization for all of the computing resources 144. Here, when the resource utilization satisfies the second maximum threshold value, the cloud computing environment 140 proceeds to operation 745 and splits the identified over utilized bucket 202 into two or more buckets 202. In particular, the cloud computing environment 140 determines an amount of computing resources 144 for each of the two or more buckets 202 that the cloud computing environment 140 splits the identified over utilized bucket 202 into based on the amount of resource utilization. Next, the cloud computing environment 140 splits the identified over utilized bucket 202 into the two buckets. Notably, a first bucket 202 of the two or more buckets 202 includes the same amount of computing resources 144 as the identified over utilized bucket. Moreover, a second bucket 202 of the two or more buckets 202 includes an amount of computing resources 144 between the two buckets 202 with the least amount of computing resources 144 above a second specified threshold. Here, the second specified threshold is less than the first specified threshold. Put another way, the cloud computing environment 140 adds the second bucket 202 of the two or more buckets 202 to the plurality of buckets 202.

In some implementations, when the resource utilization fails to satisfy the second maximum threshold value (e.g., the resource utilization does not exceed the second maximum threshold value), the cloud computing environment 140 proceeds to operation 760 and splits the identified over utilized bucket 202 into two or more buckets 202. In particular, the cloud computing environment 140 determines an amount of computing resources 144 for each of the two or more buckets 202 that the cloud computing environment 140 splits the identified over utilized bucket 202 into based on the amount of resource utilization. Next, the cloud computing environment 140 splits the identified over utilized bucket 202 into the two buckets. Notably, a first bucket 202 of the two or more buckets 202 includes the same amount of computing resources 144 as the identified over utilized bucket 202. Moreover, a second bucket 202 of the two or more buckets 202 includes an amount of computing resources 144 as a bucket 202 with the next least amount of computing resources 144 than the identified over utilized bucket 202. For example, if the identified over utilized bucket 202 is the second bucket 202b (FIG. 1), the cloud mounting environment 140 the second bucket 202 of the two or more buckets 202 includes the same amount of computing resources 144 as the third bucket 202c. In this example, the third bucket 202c has the next least amount of computing resources 144 than the second bucket 202b.

Referring now specifically to FIG. 7B, in some implementations, when the resource utilization satisfies the first maximum threshold value, the cloud computing environment 140 proceeds to operation 755 and shifts a sub-set of quota from the buckets 202 with a least amount of computing resources 144 (e.g., lowest concurrency buckets 202), to the identified over utilized bucket 202. If the resource utilization fails to satisfy the first maximum threshold value, the computing environment proceeds to operation 740 and determines whether the resource utilization satisfies a second maximum threshold value. When the resource utilization satisfies the second maximum threshold value, the cloud computing environment 140 shifts a subset of quota form medium concurrency buckets 202 to the identified over utilized bucket at operation 760. However, if the resource utilization also fails to satisfy the second max threshold value, the cloud computing environment proceeds to operation 765 and shifts a quote from an adjacent bucket to the over utilized bucket 202. For example, if the identified over utilized bucket 202 is the first bucket 202a (FIG. 1), the cloud computing environment 140 shifts computing resources 144 from the second bucket 202b. Here, the second bucket 202b is adjacent and has the next greatest amount of resources 144 than the first bucket 202a.

In some implementations, the cloud computing environment 140 determines that plurality of buckets 202 include too many (or not enough) computing resources 144 overall. That is, not just one bucket 202 of the plurality of buckets 202 include too many (or not enough) computing resources 144, but the entire system 100 (FIG. 1) includes too many (or not enough) computing resources 144. In these instances, the cloud computing environment 140 may add an additional amount of computing resources 144 or remove an amount of computing resources from the plurality of buckets 202. Accordingly, the cloud computing environment 140 must determine the additional computing resources 144 or subtract the computing resources 144 from the plurality of buckets 202.

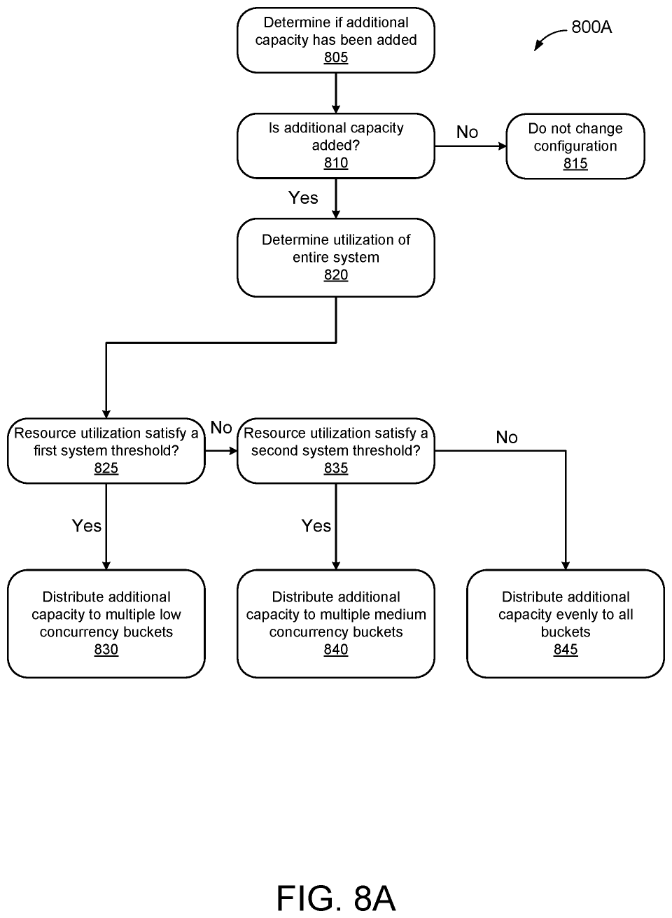

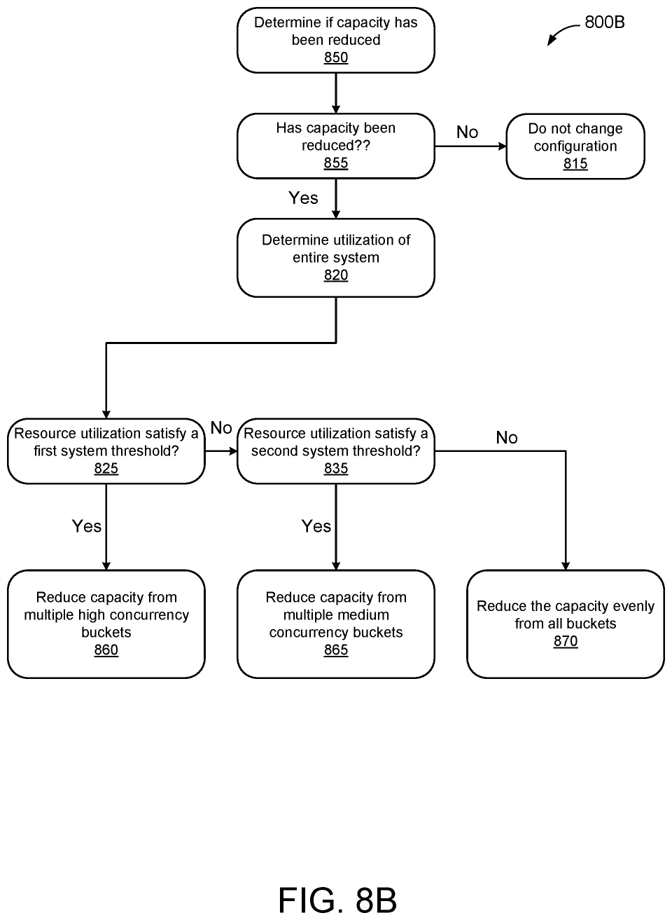

FIG. 8A illustrates a schematic view 800A that illustrates exemplary operations the cloud computing environment 140 performs when additional capacity is added to the plurality of buckets 202. In the example shown, at operation 805, the cloud computing environment 140 determines whether additional capacity has been added. At operation 810, if additional capacity has been added the cloud computing environment 140 proceeds to operation 815 and does not change the configuration of the plurality of buckets 202. When additional capacity has been added, the cloud computing environment 140 proceeds to operation 820 and determines resource utilization of the entire system.

Thereafter, at operation 825, the cloud computing environment determines whether the resource utilization of the system satisfies a first system threshold (e.g., over eighty percent). When the resource utilization of the system satisfies the first system threshold (e.g., resource utilization is over eighty percent), the cloud computing environment 140 proceeds to operation 830 and distributes the additional capacity of computing resources 144 to multiple buckets 202 with low amount of computing resources 144. If the resource utilization of the system does not satisfy the first system threshold (e.g., resource utilization is below eighty percent), at operation 835, the cloud computing environment 140 determines whether the resource utilization satisfies a second system threshold (e.g., between fifty and eighty percent). When the resource utilization satisfies the second system threshold, the cloud computing environment 140 proceeds to operation 840 and distributes the additional computing resource 144 capacity to multiple medium concurrency buckets 202. However, if the resource utilization fails to satisfy the second system threshold, the cloud computing environment 140 proceeds to operation 845 and distributes the additional computing resource 144 capacity to each bucket 202 of the plurality of buckets 202.

FIG. 8B illustrates a schematic view 800B that illustrates exemplary operations the cloud computing environment 140 performs when computing resource 144 capacity is reduced from the plurality of buckets 202. In the example shown, at operation 850, the cloud computing environment 140 determines whether computing resource capacity has been reduced from the plurality of buckets 202 (i.e., the system 100). At operation 855, if computing resource 144 capacity has been reduced from the plurality of buckets 202, the cloud computing environment 140 proceeds to operation 815 and does not change the configuration of the plurality of buckets 202. When computing resource capacity has been reduced, the cloud computing environment 140 proceeds to operation 820 and determines resource utilization of the entire system.

Thereafter, at operation 825, the cloud computing environment determines whether the resource utilization of the system satisfies a first system threshold (e.g., over eighty percent). When the resource utilization of the system satisfies the first system threshold (e.g., resource utilization is over eighty percent), the cloud computing environment 140 proceeds to operation 860 and reduces computing resource 144 capacity from multiple buckets 202 with a high amount of computing resources 144. If the resource utilization of the system does not satisfy the first system threshold (e.g., resource utilization is below eighty percent), at operation 865, the cloud computing environment 140 determines whether the resource utilization satisfies a second system threshold (e.g., between fifty and eighty percent). When the resource utilization satisfies the second system threshold, the cloud computing environment 140 proceeds to operation 865 and reduces computing resource 144 capacity from multiple buckets 202 with a medium amount of computing resources 144. However, if the resource utilization fails to satisfy the second system threshold, the cloud computing environment 140 proceeds to operation 870 and reduces computing resource capacity evenly from each bucket 202 of the plurality of buckets 202. Here, reducing capacity from a bucket 202 refers to removing computing resources 144 that are currently allocated to the respective bucket 202.

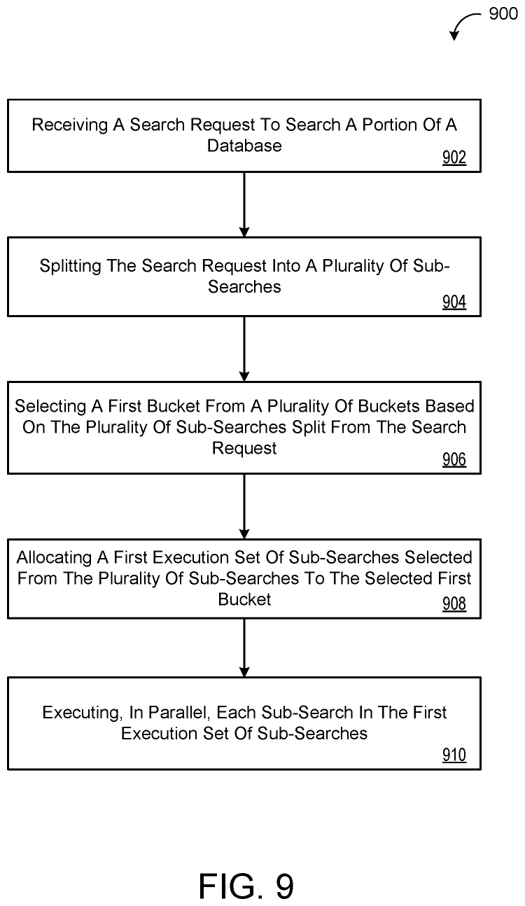

FIG. 9 is a flowchart of an exemplary arrangement of operations for a computer-implemented method 900 of parallelization of user requests. At operation 902, the method 900 includes receiving a search request 104 to search a portion of a data store 170. At operation 904, the method 900 includes splitting the search request 104 into a plurality of sub-searches 152, 152a—n. When executed, each sub-search 152 of the plurality of sub-searches 152 is configured to search a different respective sub-portion of the portion of the data store 170. At operation 906, the method 900 includes selecting a first bucket 202a from a plurality of buckets 202 based on the plurality of sub-searches 152 split from the search request 104. Each bucket 202 of the plurality of buckets 202 is associated with a respective amount of available resources 144 capable of executing a corresponding maximum number of sub-searches 152 in parallel. At operation 908, the method 900 includes allocating a first execution set of sub-searches 152, 152S1 selected from the plurality of sub-searches 152 to the selected first bucket 202a. Here a number of sub-searches 152 in the first execution set 152S1 of sub-searches 152 is less than or equal to the corresponding maximum number of sub-searches that the respective amount of available resources 144, 144a associated with the selected first bucket 202a is capable of executing in parallel. At operation 910, the method 900 includes executing, in parallel, each sub-search 152 in the first execution set 152S1 of sub-searches 152 using the respective amount of available resources 144a associated with the selected first bucket 202a.

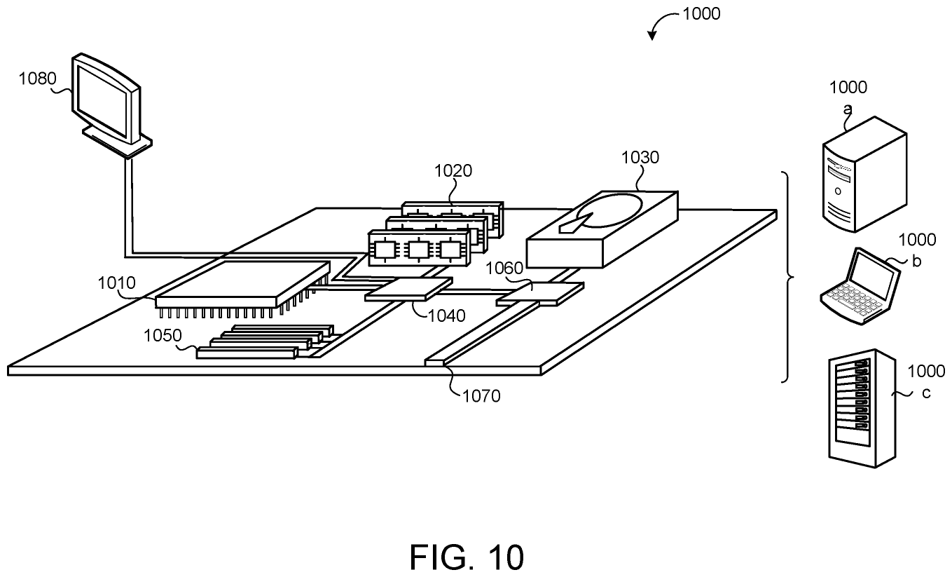

FIG. 10 is schematic view of an example computing device 1000 that may be used to implement the systems and methods described in this document. The computing device 1000 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 1000 includes a processor 1010, memory 1020, a storage device 1030, a high-speed interface/controller 1040 connecting to the memory 1020 and high-speed expansion ports 1050, and a low speed interface/controller 1060 connecting to a low speed bus 1070 and a storage device 1030. Each of the components 1010, 1020, 1030, 1040, 1050, and 1060, are interconnected using various busses, and may be mounted on a common motherboard or in other manners as appropriate. The processor 1010 can process instructions for execution within the computing device 1000, including instructions stored in the memory 1020 or on the storage device 1030 to display graphical information for a graphical user interface (GUI) on an external input/output device, such as display 1080 coupled to high speed interface 1040. In other implementations, multiple processors and/or multiple buses may be used, as appropriate, along with multiple memories and types of memory. Also, multiple computing devices 1000 may be connected, with each device providing portions of the necessary operations (e.g., as a server bank, a group of blade servers, or a multi-processor system).

The memory 1020 stores information non-transitorily within the computing device 1000. The memory 1020 may be a computer-readable medium, a volatile memory unit(s), or non-volatile memory unit(s). The non-transitory memory 1020 may be physical devices used to store programs (e.g., sequences of instructions) or data (e.g., program state information) on a temporary or permanent basis for use by the computing device 1000. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 1030 is capable of providing mass storage for the computing device 1000. In some implementations, the storage device 1030 is a computer-readable medium. In various different implementations, the storage device 1030 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 1020, the storage device 1030, or memory on processor 1010.

The high speed controller 1040 manages bandwidth-intensive operations for the computing device 1000, while the low speed controller 1060 manages lower bandwidth-intensive operations. Such allocation of duties is exemplary only. In some implementations, the high-speed controller 1040 is coupled to the memory 1020, the display 1080 (e.g., through a graphics processor or accelerator), and to the high-speed expansion ports 1050, which may accept various expansion cards (not shown). In some implementations, the low-speed controller 1060 is coupled to the storage device 1030 and a low-speed expansion port 1090. The low-speed expansion port 1090, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 1000 may be implemented in a number of different forms, as shown in the figure. For example, it may be implemented as a standard server 1000a or multiple times in a group of such servers 1000a, as a laptop computer 1000b, or as part of a rack server system 1000c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method when executed on data processing hardware causes the data processing hardware to perform operations comprising:
receiving a search request to search a portion of a data store;
splitting the search request into a plurality of sub-searches, each sub-search of the plurality of sub-searches, when executed, configured to search a different respective sub-portion of the portion of the data store;
selecting a first bucket from a plurality of buckets based on the plurality of sub-searches split from the search request, each bucket of the plurality of buckets associated with a respective amount of available resources capable of executing a corresponding maximum number of sub-searches in parallel;
allocating, to the selected first bucket, a first execution set of sub-searches selected from the plurality of sub-searches, wherein a number of sub-searches in the first execution set of sub-searches is less than or equal to the corresponding maximum number of sub-searches that the respective amount of available resources associated with the selected first bucket is capable of executing in parallel; and
executing, in parallel, each sub-search in the first execution set of sub-searches using the respective amount of available resources associated with the selected first bucket.

2. The computer-implemented method of claim 1, wherein, when a number of the sub-searches in the plurality of sub-searches split from the search request is less than or equal to the corresponding maximum number of sub-searches that the respective amount of available resources associated with the selected first bucket is capable of executing in parallel, the first execution set of sub-searches comprises all of the sub-searches in the plurality of sub-searches split from the search request.

3. The computer-implemented method of claim 1, wherein the operations further comprise:
determining whether the first bucket is available; and
when the first bucket is available:
allocating the first execution set of sub-searches to the selected first bucket; and
executing, in parallel, each sub-search in the first execution set of sub-searches using the respective amount of available resources associated with the selected first bucket.

4. The computer-implemented method of claim 3, wherein the operations further comprise:
selecting a second bucket from the plurality of buckets, wherein the corresponding maximum number of sub-searches that the respective amount of available resources associated with the selected second bucket is capable of executing in parallel is less than the corresponding maximum number of sub-searches that the respective amount of available resources associated with the first bucket is capable of executing in parallel;
determining whether the second bucket is available; and
when the second bucket is available:
allocating, to the selected second bucket, a second execution set of sub-searches selected from the plurality of sub-searches, wherein a number of sub-searches in the second execution set of sub-searches is less than or equal to the corresponding maximum number of sub-searches that the respective amount of available resources associated with the selected second bucket is capable of executing in parallel; and
executing, in parallel, each sub-search in the second execution set of sub-searches using the respective amount of available resources associated with the selected second bucket.

5. The computer-implemented method of claim 4, wherein the operations further comprise, when the second bucket is not available:
selecting a third bucket from the plurality of buckets, wherein the corresponding maximum number of sub-searches that the respective amount of available resources associated with the selected third bucket is capable of executing in parallel is one;
determining whether the third bucket is available; and
when the third bucket is available:
allocating, to the selected third bucket, a single sub-search selected from the plurality of sub-searches; and
executing the single sub-search using the respective amount of available resources associated with the selected third bucket.

6. The computer-implemented method of claim 4, wherein the operations further comprise, after allocating the second execution set of sub-searches to the selected second bucket:
identifying one or more sub-searches from the plurality of sub-searches that were not selected for inclusion in the second execution set of sub-searches;
waiting until execution of each sub-search in the second execution set of sub-searches using the respective amount of available resources associated with the selected second bucket is complete;
allocating, to the selected second bucket, the identified one or more sub-searches from the plurality of sub-searches that were not selected for inclusion in the second execution set of sub-searches; and
executing, in parallel, each sub-search of the identified one or more sub-searches using the respective amount of available resources associated with the selected second bucket.

7. The computer-implemented method of claim 1, wherein the search request comprises a raw log search of an Internet Protocol (IP) address.

8. The computer-implemented method of claim 1, wherein the operations further comprise:
receiving, for each sub-search of the plurality of sub-searches, a respective result;
compiling each received result to generate a composite search result; and
returning the composite search result to a user associated with the search request.

9. The computer-implemented method of claim 1, wherein the operations further comprise, after allocating the first execution set of sub-searches to the selected first bucket, setting the selected first bucket as not available.

10. The computer-implemented method of claim 1, wherein the operations further comprise, after execution of each sub-search in the first execution set of sub-searches using the respective amount of available resources associated with the selected first bucket is complete, setting the selected first bucket as available.

11. A system comprising:
data processing hardware; and
memory hardware in communication with the data processing hardware, the memory hardware storing instructions that when executed on the data processing hardware cause the data processing hardware to perform operations comprising:
receiving a search request to search a portion of a data store;
splitting the search request into a plurality of sub-searches, each sub-search of the plurality of sub-searches, when executed, configured to search a different respective sub-portion of the portion of the data store;
selecting a first bucket from a plurality of buckets based on the plurality of sub-searches split from the search request, each bucket of the plurality of buckets associated with a respective amount of available resources capable of executing a corresponding maximum number of sub-searches in parallel;
allocating, to the selected first bucket, a first execution set of sub-searches selected from the plurality of sub-searches, wherein a number of sub-searches in the first execution set of sub-searches is less than or equal to the corresponding maximum number of sub-searches that the respective amount of available resources associated with the selected first bucket is capable of executing in parallel; and
executing, in parallel, each sub-search in the first execution set of sub-searches using the respective amount of available resources associated with the selected first bucket.

12. The system of claim 11, wherein, when a number of the sub-searches in the plurality of sub-searches split from the search request is less than or equal to the corresponding maximum number of sub-searches that the respective amount of available resources associated with the selected first bucket is capable of executing in parallel, the first execution set of sub-searches comprises all of the sub-searches in the plurality of sub-searches split from the search request.

13. The system of claim 11, wherein the operations further comprise:
determining whether the first bucket is available; and
when the first bucket is available:
allocating the first execution set of sub-searches to the selected first bucket; and
executing, in parallel, each sub-search in the first execution set of sub-searches using the respective amount of available resources associated with the selected first bucket.

14. The system of claim 13, wherein the operations further comprise, when the first bucket is not available:
selecting a second bucket from the plurality of buckets, wherein the corresponding maximum number of sub-searches that the respective amount of available resources associated with the selected second bucket is capable of executing in parallel is less than the corresponding maximum number of sub-searches that the respective amount of available resources associated with the first bucket is capable of executing in parallel;
determining whether the second bucket is available; and
when the second bucket is available:
allocating, to the selected second bucket, a second execution set of sub-searches selected from the plurality of sub-searches, wherein a number of sub-searches in the second execution set of sub-searches is less than or equal to the corresponding maximum number of sub-searches that the respective amount of available resources associated with the selected second bucket is capable of executing in parallel; and
executing, in parallel, each sub-search in the second execution set of sub-searches using the respective amount of available resources associated with the selected second bucket.

15. The system of claim 14, wherein the operations further comprise, when the second bucket is not available:
selecting a third bucket from the plurality of buckets, wherein the corresponding maximum number of sub-searches that the respective amount of available resources associated with the selected third bucket is capable of executing in parallel is one;
determining whether the third bucket is available; and
when the third bucket is available:
allocating, to the selected third bucket, a single sub-search selected from the plurality of sub-searches; and
executing the single sub-search using the respective amount of available resources associated with the selected third bucket.

16. The system of claim 14, wherein the operations further comprise, after allocating the second execution set of sub-searches to the selected second bucket:
identifying one or more sub-searches from the plurality of sub-searches that were not selected for inclusion in the second execution set of sub-searches;
waiting until execution of each sub-search in the second execution set of sub-searches using the respective amount of available resources associated with the selected second bucket is complete;
allocating, to the selected second bucket, the identified one or more sub-searches from the plurality of sub-searches that were not selected for inclusion in the second execution set of sub-searches; and
executing, in parallel, each sub-search of the identified one or more sub-searches using the respective amount of available resources associated with the selected second bucket.

17. The system of claim 11, wherein the search request comprises a raw log search of an Internet Protocol (IP) address.

18. The system of claim 11, wherein the operations further comprise:
receiving, for each sub-search of the plurality of sub-searches, a respective result;
compiling each received result to generate a composite search result; and
returning the composite search result to a user associated with the search request.

19. The system of claim 11, wherein the operations further comprise, after allocating the first execution set of sub-searches to the selected first bucket, setting the selected first bucket as not available.

20. The system of claim 11, wherein the operations further comprise, after execution of each sub-search in the first execution set of sub-searches using the respective amount of available resources associated with the selected first bucket is complete, setting the selected first bucket as available.

21. A computer program product encoded on a non-transitory computer readable storage medium comprising instructions that when executed by a data processing apparatus cause the data processing apparatus to perform operations comprising:
receiving a search request to search a portion of a data store;
splitting the search request into a plurality of sub-searches, each sub-search of the plurality of sub-searches, when executed, configured to search a different respective sub-portion of the portion of the data store;
selecting a first bucket from a plurality of buckets based on the plurality of sub-searches split from the search request, each bucket of the plurality of buckets associated with a respective amount of available resources capable of executing a corresponding maximum number of sub-searches in parallel;
allocating, to the selected first bucket, a first execution set of sub-searches selected from the plurality of sub-searches, wherein a number of sub-searches in the first execution set of sub-searches is less than or equal to the corresponding maximum number of sub-searches that the respective amount of available resources associated with the selected first bucket is capable of executing in parallel; and
executing, in parallel, each sub-search in the first execution set of sub-searches using the respective amount of available resources associated with the selected first bucket.

22. The computer program product of claim 21, wherein, when a number of the sub-searches in the plurality of sub-searches split from the search request is less than or equal to the corresponding maximum number of sub-searches that the respective amount of available resources associated with the selected first bucket is capable of executing in parallel, the first execution set of sub-searches comprises all of the sub-searches in the plurality of sub-searches split from the search request.

23. The computer program product of claim 21, wherein the operations further comprise:
determining whether the first bucket is available; and
when the first bucket is available:
allocating the first execution set of sub-searches to the selected first bucket; and
executing, in parallel, each sub-search in the first execution set of sub-searches using the respective amount of available resources associated with the selected first bucket.

24. The computer program product of claim 23, wherein the operations further comprise:
selecting a second bucket from the plurality of buckets, wherein the corresponding maximum number of sub-searches that the respective amount of available resources associated with the selected second bucket is capable of executing in parallel is less than the corresponding maximum number of sub-searches that the respective amount of available resources associated with the first bucket is capable of executing in parallel;
determining whether the second bucket is available; and
when the second bucket is available:
allocating, to the selected second bucket, a second execution set of sub-searches selected from the plurality of sub-searches, wherein a number of sub-searches in the second execution set of sub-searches is less than or equal to the corresponding maximum number of sub-searches that the respective amount of available resources associated with the selected second bucket is capable of executing in parallel; and
executing, in parallel, each sub-search in the second execution set of sub-searches using the respective amount of available resources associated with the selected second bucket.

25. The computer program product of claim 24, wherein the operations further comprise, when the second bucket is not available:
selecting a third bucket from the plurality of buckets, wherein the corresponding maximum number of sub-searches that the respective amount of available resources associated with the selected third bucket is capable of executing in parallel is one;
determining whether the third bucket is available; and
when the third bucket is available:
allocating, to the selected third bucket, a single sub-search selected from the plurality of sub-searches; and
executing the single sub-search using the respective amount of available resources associated with the selected third bucket.

26. The computer program product of claim 24, wherein the operations further comprise, after allocating the second execution set of sub-searches to the selected second bucket:
identifying one or more sub-searches from the plurality of sub-searches that were not selected for inclusion in the second execution set of sub-searches;
waiting until execution of each sub-search in the second execution set of sub-searches using the respective amount of available resources associated with the selected second bucket is complete;
allocating, to the selected second bucket, the identified one or more sub-searches from the plurality of sub-searches that were not selected for inclusion in the second execution set of sub-searches; and
executing, in parallel, each sub-search of the identified one or more sub-searches using the respective amount of available resources associated with the selected second bucket.

27. The computer program product of claim 21, wherein the search request comprises a raw log search of an Internet Protocol (IP) address.

28. The computer program product of claim 21, wherein the operations further comprise:
receiving, for each sub-search of the plurality of sub-searches, a respective result;
compiling each received result to generate a composite search result; and
returning the composite search result to a user associated with the search request.

29. The computer program product of claim 21, wherein the operations further comprise, after allocating the first execution set of sub-searches to the selected first bucket, setting the selected first bucket as not available.

30. The computer program product of claim 21, wherein the operations further comprise, after execution of each sub-search in the first execution set of sub-searches using the respective amount of available resources associated with the selected first bucket is complete, setting the selected first bucket as available.
